(19) United States
(12) Patent Application Publication
(10) Pub. No.: US 2025/0133376 A1
(43) Pub. Date: Apr. 24, 2025

(54) METHOD FOR PROVIDING SENSING DATA AND NETWORK DEVICE

(71) Applicant: GUANGDONG OPPO MOBILE TELECOMMUNICATIONS CORP., LTD., Dongguan (CN)

(72) Inventor: Yali GUO, Dongguan (CN)

(21) Appl. No.: 19/000,870

(22) Filed: Dec. 24, 2024

Related U.S. Application Data
(63) Continuation of application No. PCT/CN2022/101938, filed on Jun. 28, 2022.

(51) Int. Cl. H04W 4/38; H04W 8/22

(52) U.S. Cl. CPC H04W 4/38; H04W 8/22

(57) ABSTRACT

Provided is a method for providing sensing data, applicable to a sensing application server, the method includes: receiving a sensing instruction from a sensing network element, wherein the sensing instruction is for instructing the sensing application server to execute a sensing service; and providing, based on the sensing instruction, sensing data related to the sensing service to at least one of the sensing network element or a first address for collecting the sensing data.

### CROSS-REFERENCE TO RELATED APPLICATION

This application is a continuation of International Application No. PCT/CN2022/101938, filed on Jun. 28, 2022, the entire disclosure of which is hereby incorporated herein by reference.

### TECHNICAL FIELD

Embodiments of the present disclosure relate to the technical field of communications, and in particular, to a method for providing sensing data and a network device.

### BACKGROUND

At present, the cellular network has only a communication capability, and further research is needed to expand the capability of the cellular network.

### SUMMARY

Embodiments of the present disclosure provide a method for providing sensing data and a network device.

According to some embodiments of the present disclosure, a method for providing sensing data is provided, wherein the method for providing sensing data is applicable to a sensing network element and includes:
sending a sensing instruction to a sensing application server, wherein the sensing instruction is for instructing the sensing application server to execute a sensing service; and
providing sensing data corresponding to the sensing service and/or a sensing analysis result corresponding to the sensing service to a target device.

According to some embodiments of the present disclosure, a method for providing sensing data is provided, wherein the method for providing sensing data is applicable to a sensing application server and includes:
receiving a sensing instruction from a sensing network element, wherein the sensing instruction is for instructing the sensing application server to execute a sensing service; and
providing, based on the sensing instruction, sensing data related to the sensing service to the sensing network element and/or a first address for collecting the sensing data.

According to an aspect of the embodiments of the present disclosure, a network device is provided, wherein the network device includes a processor and a memory configured to store one or more computer programs, wherein the processor, when loading and running the one or more computer programs, is caused to perform the above method for providing sensing data on a sensing network element side, or perform the above method for providing sensing data on a sensing application server side.

### BRIEF DESCRIPTION OF DRAWINGS

FIG. 1 is a schematic diagram of an architecture of a network according to some embodiments of the present disclosure;

FIG. 2 is an architecture diagram of a 5G system according to some embodiments of the present disclosure;

FIG. 3 is an architecture diagram of a 5G system according to some other embodiments of the present disclosure;

FIG. 4 is a flowchart of a method for providing sensing data according to some embodiments of the present disclosure;

FIG. 5 is a flowchart of a method for providing sensing data according to some other embodiments of the present disclosure;

FIG. 6 is a flowchart of a method for providing sensing data according to some other embodiments of the present disclosure;

FIG. 7 is a flowchart of a method for providing sensing data according to some other embodiments of the present disclosure;

FIG. 8 is a flowchart of a method for providing sensing data according to some other embodiments of the present disclosure;

FIG. 9 is a block diagram of an apparatus for providing sensing data according to some embodiments of the present disclosure;

FIG. 10 is a block diagram of an apparatus for providing sensing data according to some other embodiments of the present disclosure; and

FIG. 11 is a block diagram of a network device according to some embodiments of the present disclosure.

### DETAILED DESCRIPTION

To make the objective, technical solutions, and advantages of the present disclosure clearer, the embodiments of the present disclosure will be further described in detail with reference to the accompanying drawings.

A network architecture and a service scenario described in the embodiments of the present disclosure are intended to more clearly describe the technical solutions in the embodiments of the present disclosure, and do not constitute a limitation on the technical solutions provided in the embodiments of the present disclosure. A person of ordinary skill in the art may understand that, with the evolution of the network architecture and the emergence of a new service scenario, the technical solutions provided in the embodiments of the present disclosure are also applicable to a similar technical problem.

The technical solutions in the embodiments of the present disclosure are applicable to various communication systems, such as a global system for mobile communications (GSM), a code division multiple access (CDMA) system, a wideband code division multiple access (WCDMA) system, a general packet radio system (GPRS), a long term evolution (LTE) system, an LTE-advanced (LTE-A) system, an NR system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi) network, a 5G communication system, or another communication system.

Generally, the conventional communication system supports a limited quantity of connections and is easy to implement. However, with development of communication technologies, a mobile communication system supports device to device (D2D) communication, machine to machine (M2M) communication, machine type communication (MTC), vehicle to vehicle (V2V) communication, vehicle to everything (V2X) communication, and the like in addition to conventional communication. The embodiments of the present disclosure are applicable to these communication systems.

The communication system in the embodiments of the present disclosure is applicable to a carrier aggregation (CA) scenario, a dual connectivity (DC) scenario, and a standalone (SA) networking scenario.

The communication system in the embodiments of the present disclosure is applicable to an unlicensed spectrum. The unlicensed spectrum may also be considered as a shared spectrum. Alternatively, the communication system in the embodiments of the present disclosure is applicable to a licensed spectrum. The licensed spectrum may also be considered as an unshared spectrum.

The embodiments of the present disclosure are applied to the NTN system and a terrestrial network (TN) system.

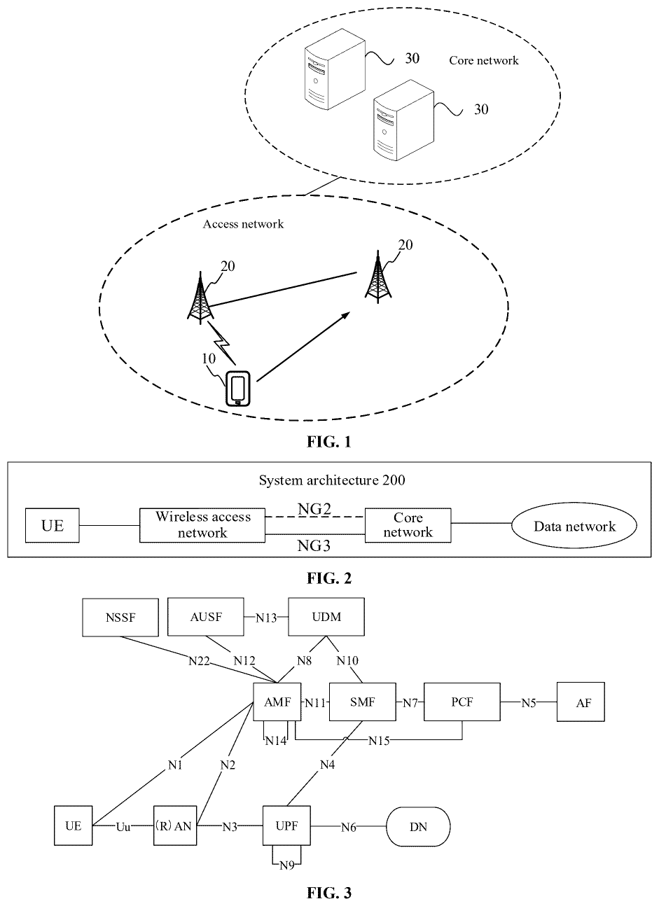

FIG. 1 is a schematic diagram of a network architecture according to some embodiments of the present disclosure. The network architecture includes a terminal device 10, an access network (AN) device 20, and a CN element 30.

The terminal device 10 is a user equipment (UE), an access terminal, a subscriber unit, a subscriber station, a mobile station, a mobile platform, a remote station, a remote terminal, a mobile device, a wireless communication device, a user agent, or a user apparatus. In some embodiments, the terminal device 10 is alternatively a cellular phone, a cordless phone, a SIP phone, a wireless local loop (WLL) station, a personal digital assistant (PDA), a handheld device with a wireless communication function, a computing device or another processing device connected to a wireless modem, a vehicle-mounted device, a wearable device, a terminal device in a 5G system, a terminal device in a future evolved public land mobile network (PLMN), or the like. This is not limited in the embodiments of the present disclosure. For convenience of description, the devices mentioned above are collectively referred to as the terminal device. There are usually a plurality of terminal devices 10. One or more terminal devices 10 are distributed in a cell managed by each AN device 20. In the embodiments of the present disclosure, the “terminal device” and “UE” are usually used interchangeably, but a person skilled in the art can understand their meanings.

The AN device 20 is a device deployed in an AN to provide a wireless communication function for the terminal device 10. The AN device 20 includes various forms of macro base stations, micro base stations, relay stations, access points, and the like. In systems employing different radio access technologies, devices with a function of the AN device may have different names, for example, gNodeB or gNB in a 5G NR system. As the communication technology evolves, the name “AN device” may change. For convenience of description, in the embodiments of the present disclosure, apparatuses providing the wireless communication function for the terminal device 10 are collectively referred to as the AN device. In some embodiments, a communication relationship is established between the terminal device 10 and the CN element 30 via the AN device 20. For example, in an LTE system, the AN device 20 is one or more eNodeBs in an evolved universal terrestrial radio access network (E-UTRAN). In the 5G NR system, the AN device 20 is one or more gNBs in a radio access network (RAN).

The CN element 30 is a network element deployed in a CN. The main functions of the CN element 30 are to provide user connections, manage users, complete bearers for services, and provide an interface to an external network as a bearer network. For example, CN elements in the 5G NR system include network elements such as an access and mobility management function (AMF), a user plane function (UPF), and a session management function (SMF). In addition, the CN element is regarded as a function entity. One or more CN elements are deployed on one physical device.

In some embodiments, the AN device 20 and the CN element 30 communicate with each other through a specific air interface technology, such as an NG interface in the 5G NR system. The AN device 20 and the terminal device 10 communicate with each other through a specific air interface technology, such as a Uu interface.

The “5G NR system” in the embodiments of the present disclosure may also be referred to as a 5G system or an NR system, but a person skilled in the art can understand its meaning. The technical solutions described in the embodiments of the present disclosure is applicable to the LTE system, the 5G NR system, an evolved system subsequent to the 5G NR system, a Narrowband Internet of Things (NB-IoT) system, or the like. This is not limited in the present disclosure.

In the embodiments of the present disclosure, the AN device provides services for a cell. The terminal device communicates with the AN device over transmission resources (for example, frequency domain resources or spectrum resources) on a carrier used by the cell. The cell may be a cell corresponding to the AN device (for example, a base station). The cell may belong to a macro base station or a base station corresponding to a small cell. The small cell includes a metro cell, micro cell, pico cell, femto cell, or the like. The small cell features small coverage and low transmission power, and is suitable for providing high-rate data transmission services.

FIG. 2 is a schematic diagram of a 5G system architecture according to some embodiments of the present disclosure. As shown in FIG. 2, the system architecture 200 includes UE (namely the “terminal device” as described above), a (radio) AN ((R)AN), a CN, and a data network (DN). The UE, (R)AN, and CN are main components of the architecture. Logically, they may be divided into two parts: a user plane and a control plane. The control plane is responsible for managing a mobile network. The user plane is responsible for transmitting service data. In the figure, an NG2 reference point is located between the (R)AN control plane and the CN control plane. An NG3 reference point is located between the (R)AN user plane and the CN user plane. An NG6 reference point is located between the CN user plane and the DN.

The UE is an entrance for a mobile user to interact with the network, and capable of providing basic computing capabilities and storage capabilities, displaying a service window to the user, and receiving user operation input. The UE establishes a signal connection and a data connection to the (R)AN through a next-generation air interface technology, to transmit control signals and service data to the mobile network.

The (R)AN is similar to a base station in a conventional network. Deployed close to the UE, the (R)AN provides a network access function for an authorized user in a specific area and can transmit user data over transmission tunnels of different quality based on a user level and a service requirement. The (R)AN manages its own resources, properly utilize them, provides an access service for the UE as needed, and forwards control signals and user data between the UE and the CN.

The CN is responsible for maintaining subscription data of the mobile network, managing network elements of the mobile network, and providing functions such as session management, mobility management, policy management, and security authentication for the UE. The CN provides network access authentication for the UE when the UE registers; allocates network resources to the UE when the UE has a service request; updates network resources for the UE when the UE moves; provides a fast recovery mechanism for the UE when the UE is idle; releases network resources for the UE when the UE deregisters; and provides a data routing function for the UE when the UE has service data, such as forwarding uplink (UL) data to the DN or receiving downlink (DL) data for the UE from the DN and forwarding the DL data to the (R)AN to send the DL data to the UE.

The DN provides services for users. Generally, a client is located on the UE and a server is located in the DN. The DN is a private network, such as a local area network; an external network not controlled by an operator, such as the Internet; or a proprietary network jointly deployed by operators, such as for configuring an IP multimedia subsystem (IMS) service.

FIG. 3 is a detailed architecture determined on the basis of FIG. 2. The CN user plane includes a UPF. The CN control plane includes an authentication server function (AUSF), an AMF, an SMF, a network slice selection function (NSSF), a network exposure function (NEF), a network repository function (NRF), a unified data management (UDM), a policy control function (PCF), an application function (AF).

In the architecture shown in FIG. 3, the UE establishes an access stratum (AS) connection to the (R)AN via the Uu interface to exchange AS messages and wirelessly transmit data. The UE establishes a non-access stratum (NAS) connection to the AMF via an N1 interface to exchange NAS messages. The AMF is a mobility management function in the CN. The SMF is a session management function in the CN. In addition to performing mobility management for the UE, the AMF is responsible for forwarding messages related to session management between the UE and the SMF. The PCF is a policy management function in the CN, responsible for formulating policies related to mobility management, session management, charging, and the like for the UE. The UPF is a user plane function in the CN, and transmits data with an external DN via an N6 interface and with the (R)AN via an N3 interface.

It should be noted that names of interfaces between network elements in FIG. 2 and FIG. 3 are merely examples. In specific implementations, the interfaces may have other names. This is not specifically limited in the embodiments of the present disclosure. Names of the network elements (such as the SMF, AF, and UPF) in FIG. 2 and FIG. 3 are also merely examples, and do not constitute a limitation on functions of the network elements. In the 5G system and a future network, the network elements may also have other names. This is not specifically limited in the embodiments of the present disclosure. For example, in a 6G network, at least one or all of the foregoing network elements may follow the terminology in 5G or have other names. This is described only herein and will not be repeated hereinafter. In addition, it should be understood that a name of a message (or signaling) transmitted between the foregoing network elements is merely an example, and does not constitute any limitation on a function of the message.

In some embodiments, policy-related network elements are mainly the PCF, the AMF, the SMF, the RAN, and the UE. The SMF is mainly used for executing a session-related policy, while the AMF is mainly used for executing policies related to access and UE policies. Policy issuance and updates on the two network elements (the AMF and the SMF) are controlled by the PCF.

Specifically, regarding the UE policy, the PCF and the UE monitor information related to the UE policy through a container, including content, an identifier, and the like of the UE policy. The container is sent by the UE to the AMF over a NAS message in an uplink direction, and then transmitted transparently (without being sensed or modified) to the PCF by the AMF. Conversely, in a downlink direction, the container is sent by the PCF to the AMF, and then transmitted transparently to the UE by the AMF over the NAS message.

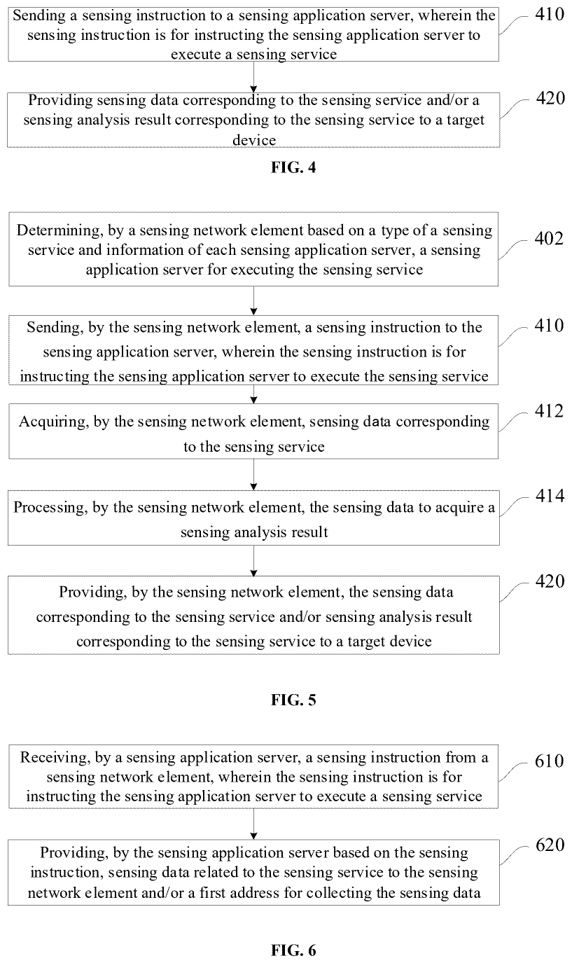

FIG. 4 is a flowchart of a method for providing sensing data according to some embodiments of the present disclosure. The method for providing sensing data is applicable to network architectures shown in FIG. 1 to FIG. 3, and is applicable to a sensing network element. As shown in FIG. 4, the method for providing sensing data may include at least one of the following steps (410 and 420).

In the step 410, the sensing network element sends a sensing instruction to a sensing application server. The sensing instruction is for instructing the sensing application server to execute a sensing service.

In some embodiments, the sensing network element is disposed in a core network, and the sensing network element is a core network element. For example, the sensing network element comprises a newly added core network element, or a network element that expands a function of an existing core network element, such that the network element can perform steps and processes that are described in the embodiments of the present disclosure and executed by the sensing network element.

In some embodiments, if the sensing network element is the newly added core network element, the sensing network element can communicate with the sensing application server, and can also communicate with a terminal device, an access network device, and other application function network elements (such as a third-party application function network element). For example, the sensing network element is connected to an AMF, and the sensing network element communicates with the terminal device and/or the access network device by using the AMF as a relay. For example, the sensing network element can also communicate directly with the terminal device and/or the access network device without using the AMF as the relay. For example, the sensing network element can communicate with the application function network element (such as the third-party application function network element) via an SMF and/or a UPF. Certainly, a specific connection relationship between the sensing network element and the existing core network element is not limited in the embodiments of the present disclosure.

In some embodiments, if the sensing network element is the network element that expands the function of the existing core network element, for example, the AMF can be functionally expanded to have a function of the sensing network element described in the embodiments of the present disclosure. Certainly, in the embodiments of the present disclosure, a function of another network element can also be expanded to enable the another network element to have the function of the sensing network element described in the embodiments of the present disclosure.

In some embodiments, the sensing application server is disposed in an operator's network, and the sensing application server manages a sensing device through an application layer to control the sensing device to collect and report sensing data.

In some embodiments, the sensing service is a service for which the sensing device performs a sensing operation and acquires sensing data corresponding to the sensing service. In the embodiments of the present disclosure, a type of the sensing device is not limited, for example, including but not limited to at least one of the following: cameras installed on roadsides, terminal devices such as mobile phones, or other locations, heart rate monitoring devices or pedometers on smart wearable devices, radars installed in cars or other locations, various types of sensors, thermometers, hygrometers, and barometers at meteorological observation points, or various types of terminal devices. Optionally, different types of sensing devices perform the same type or different types of sensing operations and collect the same type or different types of sensing data. For example, the sensing service can also be referred to as a sensing task, a sensing request, or another name. This is not limited in the present disclosure.

In some embodiments, the sensing instruction includes at least one of: a sensing type corresponding to the sensing service or a sensing area corresponding to the sensing service.

In the embodiments of the present disclosure, a classification method of the sensing type is not limited. For example, the sensing type is classified based on the type of the sensing device, and different types of sensing devices correspond to different sensing types. For another example, the sensing type is also classified based on a type of the performed sensing operation, and different types of sensing operations correspond to different sensing types. For another example, the sensing type is also classified based on a type of the collected sensing data, and different types of sensing data correspond to different sensing types. Certainly, another classification method of the sensing type is also used in the present disclosure.

The sensing area corresponding to the sensing service is an area where the sensing device executing the sensing service is located, or an area where the sensing data needs to be collected. In the embodiments of the present disclosure, a representation method of the sensing area is not limited. For example, the sensing area is represented by a geographic location area, or by a name of at least one building, or by a name or an identifier of at least one sensing device. Certainly, another method is also used to represent the sensing area in the present disclosure.

In the step 420, the sensing network element provides the sensing data corresponding to the sensing service and/or sensing analysis result corresponding to the sensing service to a target device.

The sensing data corresponding to the sensing service is data collected by the sensing device executing the sensing service, or is data acquired by processing the data collected by the sensing device executing the sensing service. For example, in a case that the sensing device includes a camera, the sensing data includes image data collected by the camera, or includes a recognition result acquired by performing recognition processing on the image data collected by the camera, such as a quantity of persons, a quantity of vehicles, and other recognition results contained in the image.

The sensing analysis result corresponding to the sensing service is a result acquired by analyzing the sensing data corresponding to the sensing service. Different sensing services correspond to different sensing analysis results. For example, the sensing analysis result is a people/vehicle flow in an area, an event of the terminal device entering an area, a quantity of terminals in an area, a location of a terminal in an area, or the like. This is not limited in the present disclosure.

The target device is a device that needs to acquire the sensing data corresponding to the sensing service and/or sensing analysis result corresponding to the sensing service. In some embodiments, the target device includes at least one of: the terminal device, the access network device, or the application function network element. The application function network element is an application function network element outside the operator's network, which can be understood as a third-party application function network element not deployed by the operator. Alternatively, the application function network element is an application function network element within the operator's network, which can be understood as an application function network element deployed by the operator. Optionally, if the target device acquires the sensing data corresponding to the sensing service, the target device processes the sensing data by itself or through another device to acquire the sensing analysis result corresponding to the sensing service.

In addition, in different application scenarios, different target devices process the received sensing data and/or sensing analysis result differently. For example, in the case that the sensing analysis result is to analyze the image data collected by the camera and determine that someone has entered or left a specific area, the access network device can turn on or off, or wireless signal coverage of the area is increased or decreased. For another example, the operator can also use some sensing devices (which may or may not be deployed by the operator) to provide the sensing service to the application function network element outside the operator's network, or to serve communication of the operator's network itself. This is not limited in the present disclosure.

In some embodiments, as shown in FIG. 5, after the above step 410, the following step 412 is further included:

In the step 412, the sensing network element acquires the sensing data corresponding to the sensing service.

In some embodiments, the sensing network element receives the sensing data corresponding to the sensing service from the sensing application server. After the sensing network element sends the sensing instruction to the sensing application server, the sensing application server can send the sensing data related to the sensing service to the sensing network element based on the sensing instruction. Correspondingly, the sensing network element receives the sensing data corresponding to the sensing service from the sensing application server.

In some embodiments, the sensing network element acquires the sensing data corresponding to the sensing service from a first address for collecting the sensing data. After the sensing network element sends the sensing instruction to the sensing application server, the sensing application server provides, based on the sensing instruction, the sensing data related to the sensing service to the first address for collecting the sensing data. Correspondingly, the sensing network element acquires the sensing data corresponding to the sensing service from the first address for collecting the sensing data.

In the embodiments of the present disclosure, an implementation form of the first address is not limited. For example, the first address is an Internet Protocol (IP) address, a domain name, or a uniform resource locator (URL). That the sensing network element acquires the sensing data corresponding to the sensing service from the first address means that the sensing network element sends a request for acquiring the sensing data corresponding to the sensing service to a device indicated by the first address. After receiving the request, the device indicated by the first address sends the sensing data corresponding to the sensing service to the sensing network element, and the sensing network element receives the sensing data corresponding to the sensing service.

In some embodiments, the sensing network element sends the first address to the sensing application server. In order to enable the sensing network element to acquire the sensing data corresponding to the sensing service from the first address, the sensing network element provides the first address to the sensing application server in advance. For example, the sensing instruction from the sensing network element to the sensing application server carries the first address. Alternatively, the first address is not carried in the sensing data but sent independently. This is not limited in the present disclosure. The sensing application server sends the collected sensing data corresponding to the sensing service to the first address, or send the first address to the sensing device executing the sensing service, such that the sensing device directly sends the collected sensing data corresponding to the sensing service to the first address. In this way, the sensing network element acquires the sensing data corresponding to the sensing service from the first address.

In some embodiments, as shown in FIG. 5, after the above step 412, the following step 414 is further included:

In the step 414, the sensing network element processes the sensing data to acquire the sensing analysis result.

After acquiring the sensing data corresponding to the sensing service, the sensing network element processes the sensing data by itself to acquire the sensing analysis result corresponding to the sensing service. For example, it is assumed that the sensing service is to acquire a people flow in an area, and the sensing data includes image data of the area over a period of time, the sensing network element performs recognition, analysis, statistics, and other operations on the above image data to acquire the people flow in the area. This example is applicable to a scenario where the sensing network element itself has an ability to analyze the sensing data.

In some embodiments, the sensing network element sends an analysis request to an analysis function network element. The analysis request is for instructing the analysis function network element to process the sensing data to acquire the sensing analysis result. The analysis function network element is a network element used for processing the sensing data. Optionally, the analysis function network element may be a core network element deployed in the core network, such as a network data analytics function (NWDAF) network element. After receiving the analysis request from the sensing network element, the analysis function network element determines the sensing data that needs to be processed, and then processes the sensing data to acquire the sensing analysis result corresponding to the sensing service. This example is applicable to a scenario where the sensing network element itself does not have the ability to analyze the sensing data.

In some embodiments, the above analysis request includes at least one of: the sensing data, an address for acquiring the sensing data, or an address for collecting the sensing analysis result.

For example, the sensing network element carries the sensing data in the analysis request and sends the sensing data to the analysis function network element, such that the analysis function network element directly acquires the sensing data that needs to be processed from the analysis request.

For example, the sensing network element also sends the address for acquiring the sensing data to the analysis function network element, such that the analysis function network element acquires the sensing data that needs to be processed from the address. Optionally, the address for acquiring the sensing data is the first address described above or another address different from the first address, which is not limited in the present disclosure. In addition, the address for acquiring the sensing data is implemented in a form of the IP address, the domain name, the URL, or the like, which is not limited in the present disclosure.

For example, after acquiring the sensing analysis result, the analysis function network element sends the sensing analysis result to the sensing network element. Correspondingly, the sensing network element receives the sensing analysis result from the sensing network element.

For example, the sensing network element also sends the address for collecting the sensing analysis result to the analysis function network element, such that the analysis function network element sends the acquired the sensing analysis result to the address. In this way, the sensing network element and/or the target device acquires the sensing analysis result from the address for collecting the sensing analysis result. Optionally, the address for collecting the sensing analysis result is a second address described below or another address different from the second address, which is not limited in the present disclosure. In addition, the address for collecting the sensing analysis result is implemented in a form of the IP address, the domain name, the URL, or the like, which is not limited in the present disclosure.

In some embodiments, that the sensing network element provides the sensing data corresponding to the sensing service and/or sensing analysis result corresponding to the sensing service to the target device includes the following two implementations.

In one possible implementation, the sensing network element sends the sensing data corresponding to the sensing service and/or sensing analysis result corresponding to the sensing service to the target device. That is, after acquiring the sensing data corresponding to the sensing service and/or sensing analysis result corresponding to the sensing service, the sensing network element sends the sensing data corresponding to the sensing service and/or sensing analysis result corresponding to the sensing service to the target device.

In the other possible implementation, the sensing network element sends the second address for acquiring the sensing data corresponding to the sensing service and/or sensing analysis result corresponding to the sensing service to the target device. That is, the sensing network element does not send the sensing data corresponding to the sensing service and/or sensing analysis result corresponding to the sensing service to the target device by itself, but sends the second address for acquiring the sensing data corresponding to the sensing service and/or sensing analysis result corresponding to the sensing service to the target device, such that the target device acquires the sensing data corresponding to the sensing service and/or sensing analysis result corresponding to the sensing service from the second address. Optionally, the second address and the first address are the same or different, which is not limited in the present disclosure. In addition, the second address is implemented in a form of the IP address, the domain name, the URL, or the like, which is not limited in the present disclosure. In addition, that the target device acquires the sensing data corresponding to the sensing service and/or sensing analysis result corresponding to the sensing service from the second address means that the target device sends a request for acquiring the sensing data corresponding to the sensing service and/or sensing analysis result corresponding to the sensing service to a device indicated by the second address. After receiving the request, the device indicated by the second address sends the sensing data corresponding to the sensing service and/or sensing analysis result corresponding to the sensing service to the target device, and the target device receives the sensing data corresponding to the sensing service and/or sensing analysis result corresponding to the sensing service.

In some embodiments, as shown in FIG. 5, before the above step 410, the following step 402 is further included.

In the step 402, based on a type of the sensing service and information of each sensing application server, the sensing network element determines the sensing application server for executing the sensing service.

When the sensing service needs to be started or executed, the sensing network element determines, based on the type of the sensing service and the information of each sensing application server, the sensing application server for executing the sensing service. For example, if the sensing service is to sense a people/vehicle flow in an area, a sensing application server that supports people/vehicle flow sensing, and/or supports camera shooting, and/or supports radar sensing can be selected.

In some embodiments, the information of the sensing application server includes at least one of: capability information of the sensing application server, or area information of the sensing application server.

The capability information of the sensing application server is indicative of a sensing capability of the sensing application server. For example, the capability information includes at least one of: a sensing information type supported by the sensing application server, a sensing information identifier, an application identifier, or the like. In the embodiments of the present disclosure, specific content of the capability information is not limited. Any information that can represent the sensing service that can be executed by the sensing application server, or any information that can represent the sensing data that can be collected can be used as the capability information of the sensing application server.

The area information of the sensing application server is indicative of an area managed by the sensing application server. For example, the area information includes at least one of: location coordinates, a name, an identifier, or the like of the area managed by the sensing application server. In the embodiments of the present disclosure, specific content of the area information is not limited. Any information that can represent the area managed by the sensing application server can be used as the area information of the sensing application server.

In some embodiments, the information of the sensing application server is stored in the sensing network element. For example, the sensing application server registers and stores its own information (including the capability information and/or the area information) in the sensing network element in advance.

In some embodiments, the information of the sensing application server is stored in a data storage network element. The data storage network element is a network element configured to store the information of the sensing application server. Optionally, the data storage network element is a network element deployed in the core network, such as an NRF network element. Optionally, if the information of the sensing application server is stored in the data storage network element, the sensing network element acquires the information of the sensing application server from the data storage network element.

In the technical solutions provided in the embodiments of the present disclosure, by means of interaction between the sensing network element and the sensing application server, the sensing service is executed and the sensing data is collected. The sensing network element provides the sensing data corresponding to the sensing service and/or sensing analysis result corresponding to the sensing service to the target device, thereby expanding sensing data collection and providing capabilities of a cellular network on the basis of an existing communication capability of the cellular network.

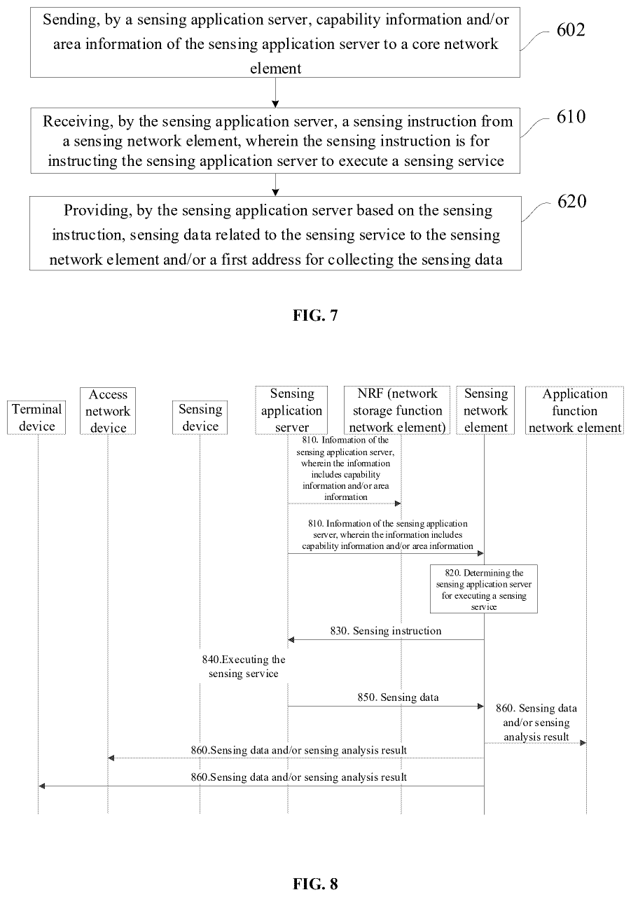

FIG. 6 is a flowchart of a method for providing sensing data according to some other embodiments of the present disclosure. The method for providing sensing data can be applied to network architectures shown in FIG. 1 to FIG. 3, and is applicable to a sensing application server. As shown in FIG. 6, the method for providing sensing data includes at least one of the following steps (610 and 620).

In the step 610, the sensing application server receives a sensing instruction from a sensing network element. The sensing instruction is for instructing the sensing application server to execute a sensing service.

In some embodiments, the sensing instruction includes at least one of: a sensing type corresponding to the sensing service or a sensing area corresponding to the sensing service.

For details not described in the step 610, reference may be made to the description about the step 410 in the above embodiments, and details are not described herein again.

In the step 620, based on the sensing instruction, the sensing application server provides sensing data related to the sensing service to the sensing network element and/or a first address for collecting the sensing data.

In some embodiments, based on the sensing instruction, the sensing application server controls at least one sensing device to perform a sensing operation related to the sensing service. The sensing application server acquires, from the sensing device, the sensing data that is related to the sensing service and acquired by the sensing operation. The sensing application server sends the sensing data related to the sensing service to the sensing network element and/or the first address.

In some embodiments, based on the sensing instruction, the sensing application server controls at least one sensing device to perform a sensing operation related to the sensing service, and triggers the sensing device to send the sensing data that is related to the sensing service and acquired by the sensing operation to the sensing network element and/or the first address. In this implementation, the sensing application server does not need to collect the sensing data from the sensing device. Instead, the sensing device directly sends the collected sensing data to the sensing network element and/or the first address. Optionally, the sensing application server sends an address of the sensing network element and/or the first address to the sensing device executing the sensing service. The collected sensing data is directly sent by the sensing device to the sensing network element and/or the first address, without being forwarded by the sensing application server, which helps to reduce a processing overhead of the sensing application server.

In some embodiments, the sensing application server also receives the first address from the sensing network element. For example, the sensing instruction from the sensing network element to the sensing application server carries the first address. Alternatively, the first address is not carried in the sensing data but sent independently. This is not limited in the present disclosure.

In some embodiments, as shown in FIG. 7, before the above step 610, the following step 602 is further included:

In the step 602, the sensing application server sends capability information and/or area information of the sensing application server to a core network element.

The capability information of the sensing application server is indicative of a sensing capability of the sensing application server. The area information of the sensing application server is indicative of an area managed by the sensing application server. Optionally, the capability information includes at least one of: a sensing information type supported by the sensing application server, a sensing information identifier, or an application identifier. Optionally, the core network element is a data storage network element or the sensing network element.

A process of reporting the capability information and/or the area information of the sensing application server has been described in the above embodiments. Reference may be made to the description in the above embodiments, and details are not described herein again.

In the technical solutions provided in the embodiments of the present disclosure, based on the sensing instruction received from the sensing network element, the sensing application server provides the sensing data related to the sensing service to the sensing network element and/or the first address for collecting the sensing data. In this way, the sensing service is executed, and the sensing data is collected and reported, thereby expanding sensing data collection and providing capabilities of a cellular network on the basis of an existing communication capability of the cellular network.

FIG. 8 is a flowchart of a method for providing sensing data according to some other embodiments of the present disclosure. The method for providing sensing data is applicable to network architectures shown in FIG. 1 to FIG. 3. As shown in FIG. 8, the method for providing sensing data includes at least one of the following steps (810 to 860).

In the step 810, a sensing application server sends its own information to an NRF and/or a sensing network element. The information includes capability information and/or area information.

The sensing application server is disposed in an operator's network, and the sensing application server manages a sensing device via an application layer to control the sensing device to collect and report sensing data. The sensing application server registers its sensing capability with a data storage network element (such as the NRF) located in a core network, and optionally provides information of an area managed by the sensing application server. For example, the sensing capability is a supported sensing information type, a sensing information identifier, an application identifier, or the like. The sensing capability registered by the sensing application server is related to the sensing device managed by the sensing application server. For example, a sensing application server manages a sensing device 1 with a camera shooting function and a sensing device 2 with a radar function. The sensing application server registers camera shooting and/or radar sensing with the data storage network element as its own sensing capability, or registers people/vehicle flow sensing as its own sensing capability (because data collected through the camera shooting and radar functions can be used to analyze a people/vehicle flow). The sensing application server also registers its sensing capability with the sensing core network element.

In the step 820, based on a type of a sensing service and information of each sensing application server, the sensing network element determines the sensing application server for executing the sensing service.

When the sensing service needs to started, the sensing network element selects the sensing application server based on the type of the sensing service. In the case that the information of the sensing application server is stored in the sensing network element, the sensing network element directly selects, based on the type of the sensing service and the information of each sensing application server stored in the sensing network element, the sensing application server for executing the sensing service. In the case that the information of the sensing application server is stored in the data storage network element, the sensing network element first queries the data storage network element to acquire the information of each sensing application server, and then selects the sensing application server for executing the sensing service based on the type of the sensing service. For example, if the sensing service is to sense a people/vehicle flow in an area, a sensing application server that supports people/vehicle flow sensing, and/or supports camera shooting, and/or supports radar sensing can be selected.

In the step 830, the sensing network element sends a sensing instruction to the sensing application server. The sensing instruction is for instructing the sensing application server to execute the sensing service.

The sensing network element sends the sensing instruction to the selected sensing application server, including a sensing type, a sensing area, and other information, to require the sensing application server to execute the corresponding sensing service. Optionally, the sensing network element sends a first address for collecting sensing data to the sensing application server.

In the step 840, based on the sensing instruction, the sensing application server controls at least one sensing device to perform a sensing operation related to the sensing service.

Based on the sensing instruction received from the sensing network element, the sensing application server controls the at least one sensing device for sensing, for example, controls at least one camera to collect video information. The sensing application server acquires sensing data (such as camera data and radar sensing data) from the sensing device, or further processes the acquired sensing data (for example, perform analysis to acquire a people/vehicle flow in an area).

In the step 850, the sensing application server provides the sensing data related to the sensing service to the sensing network element and/or the first address for collecting the sensing data.

The sensing application server sends the collected sensing data or data acquired through further processing by the sensing application server to the sensing network element, or to the first address designated by the sensing network element for collecting the sensing data.

In the step 860, the sensing network element provides the sensing data corresponding to the sensing service and/or sensing analysis result corresponding to the sensing service to a target device.

The sensing network element provides the sensing data to a terminal device, an access network device, or an application function network element. The application function network element is a third-party application function network element deployed outside the operator's network, or an application function network element deployed inside the operator's network. This is not limited in the present disclosure. The sensing network element further processes the sensing data to acquire the sensing analysis result, and then provides the sensing analysis result to the terminal device, the access network device, or the application function network element. For example, the sensing network element acquires sensing data from a plurality of sensing application servers, and provides analysis or processing results to the terminal device, the access network device, or the application function network element. The sensing analysis result is, for example, a people/vehicle flow in an area, an event of the terminal device entering an area, a quantity of terminals in an area, a location of a terminal in an area, or the like. This is not limited in the present disclosure.

Alternatively, the sensing network element sends a second address for acquiring the sensing data and/or the sensing analysis result to the terminal device, the access network device, or the application function network element outside the operator's network. The terminal device, the access network device, or the application function network element acquires the sensing data and/or the sensing analysis result from the second address. The second address is the same as or different from the first address for collecting the sensing data.

In a case, the sensing network element further analyzes and processes the sensing data by itself. For example, the sensing network element further analyzes or processes sensing data from at least one sensing application server to the sensing network element. For another example, the sensing network element acquires, from the first address for collecting the sensing data, sensing data from at least one sensing application server to the first address, and further analyzes or processes the sensing data.

In another case, the sensing network element also requests an analysis function network element in the core network, such as an NWDAF, to analyze the sensing data to acquire the sensing analysis result. The sensing network element sends the sensing data or an address for acquiring the sensing data to the NWDAF, and the NWDAF acquires the sensing data from the address for analysis. The sensing network element provides a report address of the analysis result to the NWDAF, and the NWDAF sends the analysis result to the sensing network element or the report address.

In the embodiments, the process of the method for providing sensing data is described only from a perspective of interaction between the sensing network element and the sensing application server. The above steps executed by the sensing network element are separately implemented as a method for providing sensing data on a sensing network element side, and further the above steps executed by the sensing application server are separately implemented as a method for providing sensing data on a sensing application server side.

The following are apparatus embodiments of the present disclosure, which can be used to execute the method embodiments of the present disclosure. For details not disclosed in the apparatus embodiments of the present disclosure, reference can be made to the method embodiments of the present disclosure.

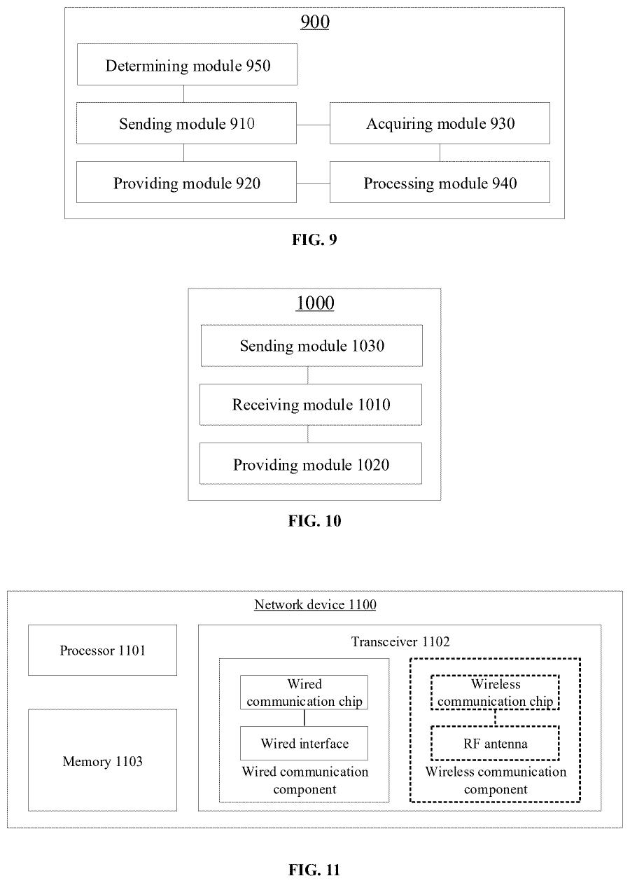

FIG. 9 is a block diagram of an apparatus for providing sensing data according to some embodiments of the present disclosure. The apparatus for providing sensing data has a function of implementing the examples of the above method for providing sensing data on a sensing network element side. The function is implemented by hardware or by hardware executing corresponding software. The apparatus for providing sensing data is a sensing network element, or is disposed in the sensing network element. As shown in FIG. 9, the apparatus for providing sensing data 900 includes a sending module 910 and a providing module 920.

The sending module 910 is configured to send a sensing instruction to a sensing application server. The sensing instruction is for instructing the sensing application server to execute a sensing service.

The providing module 920 is configured to provide sensing data corresponding to the sensing service and/or a sensing analysis result corresponding to the sensing service to a target device.

In some embodiments, the sensing instruction includes at least one of: a sensing type corresponding to the sensing service or a sensing area corresponding to the sensing service.

In some embodiments, the target device includes at least one of: a terminal device, an access network device, or an application function network element.

In some embodiments, as shown in FIG. 9, the apparatus for providing sensing data 900 further includes: an acquiring module 930 configured to acquire the sensing data corresponding to the sensing service.

In some embodiments, the acquiring module 930 is configured to receive the sensing data corresponding to the sensing service from the sensing application server; or configured to acquire the sensing data corresponding to the sensing service from a first address for collecting the sensing data.

In some embodiments, the sending module 910 is further configured to send the first address to the sensing application server.

In some embodiments, as shown in FIG. 9, the apparatus for providing sensing data 900 further includes: a processing module 940 configured to process the sensing data to acquire the sensing analysis result.

In some embodiments, the sending module 910 is further configured to send an analysis request to an analysis function network element. The analysis request is for instructing the analysis function network element to process the sensing data to acquire the sensing analysis result.

In some embodiments, the analysis request includes at least one of: the sensing data, an address for acquiring the sensing data, or an address for collecting the sensing analysis result.

In some embodiments, the providing module 920 is configured to send the sensing data corresponding to the sensing service and/or sensing analysis result corresponding to the sensing service to the target device, or send a second address for acquiring the sensing data corresponding to the sensing service and/or the sensing analysis result corresponding to the sensing service to the target device.

In some embodiments, as shown in FIG. 9, the apparatus for providing sensing data 900 further includes: a determining module 950 configured to determine, based on a type of the sensing service and information of each sensing application server, the sensing application server for executing the sensing service.

In some embodiments, the information of the sensing application server includes at least one of: capability information of the sensing application server, wherein the capability information is indicative of a sensing capability of the sensing application server; or area information of the sensing application server, wherein the area information is indicative of an area managed by the sensing application server.

In some embodiments, the capability information includes at least one of: a sensing information type supported by the sensing application server, a sensing information identifier, or an application identifier.

In some embodiments, the information of the sensing application server is stored in the sensing network element or in a data storage network element.

In some embodiments, the determining module 950 is further configured to: acquire the information of the sensing application server from the data storage network element in the case that the information of the sensing application server is stored in the data storage network element.

FIG. 10 is a block diagram of an apparatus for providing sensing data according to some other embodiments of the present disclosure. The apparatus for providing sensing data has a function of implementing the examples of the above method for providing sensing data on a sensing application server side. The function may be implemented by hardware or by hardware executing corresponding software. The apparatus for providing sensing data may be a sensing application server, or may be disposed in the sensing application server. As shown in FIG. 10, the apparatus for providing sensing data 1000 includes a receiving module 1010 and a providing module 1020.

The receiving module 1010 is configured to receive a sensing instruction from a sensing network element. The sensing instruction is for instructing the sensing application server to execute a sensing service.

The providing module 1020 is configured to provide, based on the sensing instruction, sensing data related to the sensing service to the sensing network element and/or a first address for collecting the sensing data.

In some embodiments, the sensing instruction includes at least one of: a sensing type corresponding to the sensing service or a sensing area corresponding to the sensing service.

In some embodiments, the providing module 1020 is configured to: control at least one sensing device to perform a sensing operation related to the sensing service based on the sensing instruction, acquire, from the sensing device, the sensing data that is related to the sensing service and acquired by the sensing operation, and send the sensing data related to the sensing service to the sensing network element and/or the first address; or control at least one sensing device to perform a sensing operation related to the sensing service based on the sensing instruction, and trigger the sensing device to send the sensing data that is related to the sensing service and acquired by the sensing operation to the sensing network element and/or the first address.

In some embodiments, the receiving module 1010 is further configured to receive the first address from the sensing network element.

In some embodiments, as shown in FIG. 10, the apparatus for providing sensing data 1000 further includes: a sending module 1030 configured to send capability information of the sensing application server to a core network element. The capability information is indicative of a sensing capability of the sensing application server.

In some embodiments, the capability information includes at least one of: a sensing information type supported by the sensing application server, a sensing information identifier, or an application identifier.

In some embodiments, the core network element is a data storage network element or the sensing network element.

In some embodiments, the sending module 1030 is further configured to send area information of the sensing application server to the core network element. The area information is indicative of an area managed by the sensing application server.

It should be noted that when the apparatus for providing sensing data provided in the foregoing embodiments implements its functions, division of the foregoing functional modules is merely used as an example. In practical application, the foregoing functions may be allocated to and completed by different functional modules as required, that is, an internal structure of the apparatus for providing sensing data is divided into different functional modules to complete all or some of the foregoing functions.

Specific manners of performing operations by the modules in the apparatus for providing sensing data in the above embodiments have been described in detail in the embodiments of the related method, and details are not described herein again.

FIG. 11 is a schematic structural diagram of a network device 1100 according to some embodiments of the present disclosure. The network device 1100 is the above-described sensing network element or sensing application server. The network device 1100 is configured to execute the above method for providing sensing data on a sensing network element side, or execute the above method for providing sensing data on a sensing application server side. The network device 1100 includes a processor 1101, a transceiver 1102, and a memory 1103.

The processor 1101 includes at least one processing core. The processor 1101 executes various function applications and information processing by running software programs and modules. The processor 1101 is configured to perform other steps in the above method embodiments except for the receiving and sending steps.

The transceiver 1102 includes a receiver and a transmitter. For example, the transceiver 1102 includes a wired communication component, and the wired communication component includes a wired communication chip and a wired interface (for example, a fiber interface). Optionally, the transceiver 1102 also includes a wireless communication component, and the wireless communication component includes a wireless communication chip and a radio frequency (RF) antenna. The transceiver 1102 is configured to perform the receiving and sending steps in the above method embodiments.

The memory 1103 is connected to the processor 1101 and the transceiver 1102.

The memory 1103 is configured to store a computer program executed by the processor, and the processor 1101 is configured to execute the computer program to implement each step performed by the sensing network element or the sensing application server in the above method embodiments.

In addition, the memory 1103 is implemented by any type of transitory or non-transitory storage device or a combination thereof. The transitory or non-transitory storage device includes but is not limited to: a magnetic disk or an optical disc, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In some embodiments, in the case that the network device 1100 is the sensing network element, the transceiver 1102 is configured to: send a sensing instruction to the sensing application server, wherein the sensing instruction is for instructing the sensing application server to execute a sensing service; and provide sensing data corresponding to the sensing service and/or a sensing analysis result corresponding to the sensing service to a target device.

In some embodiments, in the case that the network device 1100 is the sensing application server, the transceiver 1102 is configured to: receive a sensing instruction from the sensing network element, wherein the sensing instruction is for instructing the sensing application server to execute a sensing service; and provide, based on the sensing instruction, sensing data related to the sensing service to the sensing network element and/or a first address for collecting the sensing data.

For details not described in the above embodiments, reference may be made to the description in the above method embodiments, and details are not described herein again.

The embodiments of the present disclosure further provide a computer-readable storage medium. The storage medium stores one or more computer programs, and the computer program is applicable to a processor of a network device to implement the foregoing method for providing sensing data on a sensing network element side, or implement the method for providing sensing data on a sensing application server side.

In some embodiments, the computer-readable storage medium includes a ROM, a random access memory (RAM), a solid-state drive (SSD), an optical disc, or the like. The RAM includes a resistance random access memory (ReRAM) and a dynamic random access memory (DRAM).

The embodiments of the present disclosure further provides a chip, including a programmable logic circuit and/or a program instruction. The chip is run on a network device to perform the foregoing method for providing sensing data on a sensing network element side, or implement the method for providing sensing data on a sensing application server side.

The embodiments of the present disclosure further provide a computer program product. The computer program product includes one or more computer instructions stored in a computer-readable storage medium, wherein the one or more computer instructions, when loaded and executed by a processor of a network device, cause the network device to perform the foregoing method for providing sensing data on a sensing network element side, or perform the method for providing sensing data on a sensing application server side.

It should be understood that the term “a plurality of” in this specification means two or more. The term “and/or” describes an association between associated objects, and it indicates three types of relationships. For example, “A and/or B” may indicate that A exists alone, A and B coexist, or B exists alone. The character “/” usually indicates an “or” relationship between associated objects.

In addition, the step number in this specification only exemplifies one possible step execution order. In some other embodiments, the above steps may also be executed without following a numbering order. For example, two steps with different numbers are executed simultaneously or in an order reverse to the order shown in the figures. This is not limited in the embodiments of the present disclosure.

In addition, the solutions in the embodiments provided in the present disclosure are combined arbitrarily, and all combinations are within the protection scope of the present disclosure. Moreover, for details not described in some embodiments, reference may be made to the description of relevant content in some other embodiments.

A person skilled in the art should be aware that in the foregoing one or more examples, the functions described in the embodiments of the present disclosure may be implemented by hardware, software, firmware, or any combination thereof. When implemented by software, the functions may be stored in a computer-readable medium or transmitted as at least one instruction or code on the computer-readable medium. The computer-readable medium includes a computer storage medium and a communication medium, wherein the communication medium includes any medium that facilitates the transfer of a computer program from one place to another. The storage medium is any usable medium accessible by a general-purpose computer or a special-purpose computer.

The foregoing description is merely exemplary embodiments of the present disclosure and is not intended to limit the present disclosure. Any modification, equivalent replacement, and improvement within the principle of the present disclosure shall be included within the protection scope of the present disclosure.

1. A method for providing sensing data, applicable to a sensing application server, the method comprising:
receiving a sensing instruction from a sensing network element, wherein the sensing instruction is for instructing the sensing application server to execute a sensing service; and
providing, based on the sensing instruction, sensing data related to the sensing service to at least one of the sensing network element or a first address for collecting the sensing data.

2. The method according to claim 1, wherein the sensing instruction comprises at least one of: a sensing type corresponding to the sensing service or a sensing area corresponding to the sensing service.

3. The method according to claim 1, wherein providing, based on the sensing instruction, the sensing data related to the sensing service to at least one of the sensing network element or the first address for collecting the sensing data comprises:
controlling at least one sensing device to perform a sensing operation related to the sensing service based on the sensing instruction, acquiring, from the at least one sensing device, the sensing data that is related to the sensing service and acquired by the sensing operation, and sending the sensing data related to the sensing service to at least one of the sensing network element or the first address; or
controlling at least one sensing device to perform a sensing operation related to the sensing service based on the sensing instruction, and triggering the at least one sensing device to send the sensing data that is related to the sensing service and acquired by the sensing operation to at least one of the sensing network element or the first address.

4. The method according to claim 1, further comprising:
receiving the first address from the sensing network element.

5. The method according to claim 1, further comprising:
sending capability information of the sensing application server to a core network element, wherein the capability information is indicative of a sensing capability of the sensing application server;
wherein the capability information comprises at least one of: a sensing information type supported by the sensing application server, a sensing information identifier, or an application identifier.

6. The method according to claim 5, wherein the core network element is a data storage network element or the sensing network element.

7. The method according to claim 5, further comprising:
sending area information of the sensing application server to the core network element, wherein the area information is indicative of an area managed by the sensing application server.

8. A network device, comprising a processor and a memory storing one or more computer programs, which, when executed by the processor, the network device is configured to:
receive a sensing instruction from a sensing network element, wherein the sensing instruction is for instructing a sensing application server to execute a sensing service; and
provide, based on the sensing instruction, sensing data related to the sensing service to at least one of the sensing network element or a first address for collecting the sensing data.

9. The network device according to claim 8, wherein the sensing instruction comprises at least one of: a sensing type corresponding to the sensing service or a sensing area corresponding to the sensing service.

10. The network device according to claim 8, wherein the network device is further configured to:
control at least one sensing device to perform a sensing operation related to the sensing service based on the sensing instruction, acquire, from the at least one sensing device, the sensing data that is related to the sensing service and acquired by the sensing operation, and send the sensing data related to the sensing service to at least one of the sensing network element or the first address; or
control at least one sensing device to perform a sensing operation related to the sensing service based on the sensing instruction, and trigger the at least one sensing device to send the sensing data that is related to the sensing service and acquired by the sensing operation to at least one of the sensing network element or the first address.

11. The network device according to claim 8, wherein the network device is further configured to:
receive the first address from the sensing network element.

12. The network device according to claim 8, wherein the network device is further configured to:
send capability information of the sensing application server to a core network element, wherein the capability information is indicative of a sensing capability of the sensing application server;
wherein the capability information comprises at least one of: a sensing information type supported by the sensing application server, a sensing information identifier, or an application identifier.

13. The network device according to claim 12, wherein the core network element is a data storage network element or the sensing network element.

14. The network device according to claim 12, wherein the network device is further configured to:
send area information of the sensing application server to the core network element, wherein the area information is indicative of an area managed by the sensing application server.

15. A network device, comprising a processor and a memory storing one or more computer programs, which, when executed by the processor, the network device is configured to:
send a sensing instruction to a sensing application server, wherein the sensing instruction is for instructing the sensing application server to execute a sensing service; and
provide at least one of sensing data corresponding to the sensing service or a sensing analysis result corresponding to the sensing service to a target device.

16. The network device according to claim 15, wherein the sensing instruction comprises at least one of: a sensing type corresponding to the sensing service or a sensing area corresponding to the sensing service.

17. The network device according to claim 15, wherein the target device comprises at least one of: a terminal device, an access network device, or an application function network element.

18. The network device according to claim 15, wherein the network device is further configured to:
acquire the sensing data corresponding to the sensing service.

19. The network device according to claim 18, wherein the network device is further configured to:
receive the sensing data corresponding to the sensing service from the sensing application server; or
acquire the sensing data corresponding to the sensing service from a first address for collecting the sensing data.

20. The network device according to claim 19, wherein the network device is further configured to:
send the first address to the sensing application server.
